(19) United States
(12) Patent Application Publication
(10) Pub. No.: US 2009/0218451 A1
(43) Pub. Date: Sep. 3, 2009

(54) Cable Retention Device

(76) Inventor: Christer Lundborg, Karlskrona (SE)

Correspondence Address: HARNESS, DICKEY & PIERCE, P.L.C., P.O. BOX 8910, RESTON, VA, 20195, US

(21) Appl. No.: 12/087,858

(22) PCT Filed: Feb. 16, 2007
(86) PCT No.: PCT/SE2007/050093

§ 371 Date: Jan. 12, 2009

(30) Foreign Application Priority Data
Feb. 17, 2006 (SE) 0600367-7

(51) Int. Cl. F16L 3/08

(52) U.S. Cl. 248/56; 248/65; 248/74.4

(57) ABSTRACT

The present invention concerns a cable retention device, which also may be used for pipes or wires, to take up forces actuated by or on a cable (2) etc. Each cable (2) is received in a module, formed of two module halves (6, 55, 58, 62). The modules are received inside a rigid frame construction. The modules inside the frame construction are to be compressed. The compression is accomplished by means of a compression unit (36, 41) inside the frame construction and/or by assembly of the cable retention device.

### TECHNICAL FIELD

The present invention concerns a cable retention device to hold one or more cables and take up forces exerted by or on the one or more cables.

### PRIOR ART

In many contexts where cables are used the cables are exerted to relatively large forces. Often such forces has to be taken up to not harm the cables or apparatuses or the like receiving the cables. The forces exerted on the cables may be gravity, torsion (rotational), traction, pulling, “whiplash” (caused by e.g. short circuited cables) and/or vibration forces.

It is common to use different types of cable clamps, but ordinary cable clamps will not take up any forces. Thus, there is a high risk that the cables are harmed if exerted to relatively high forces and if the cable clamps do not yield in any substantial way. One problem being that there is no real elastic connection between the cable and a structure receiving the cable clamps.

In wind power stations (plants) the turbine and its wings are usually placed pivotally at the top of a tower. The turbine is pointed to the wind. Cables go inside the tower downwards from the turbine. The turbine is placed at a relatively high position, which means that the cables will be relatively long and heavy. Supports are needed to hold the cables and tension forces due to gravity should be taken up. As the turbine part is rotated due to the wind direction the cables will also be turned and there is a need to also take up these rotations, thus, giving torsion relief or dampening. If the forces are not taken up there is a great risk that the cables or the connection for the cables to different appliances are harmed.

The invention is not limited to use at wind power stations. It can be used in all connections where cables are exerted to forces. As indicated above it may be used for cables that are hanging, giving traction relief or dampening and also to give torsion relief or dampening. A number of cable retention devices according to the present invention may be placed at intervals along a hanging cable. The invention may also be used to absorb vibrations. If short-circuiting appears the cables often experience a whiplash effect of very high magnitude. The present invention may be used to reduce the effects of such a whiplash. The invention may also be used for cables with a horizontal extension, whereby the cable retention devices of the invention are placed at some intervals. Long horizontal cables are often present in tunnels, such as for underground trains.

Thus, there exist several different situations in which cables should be received in a way to take up different forces.

Even though the present invention is developed mainly for wind power stations a person skilled in the art realises that it may be used in many different connections. It may also be used for pipes, wires etc. instead of or together with cables. For ease of description the expression “cable” is mainly used here, but that should be construed broadly and a person skilled in the art realises that retention devices according to the present invention may also be used for pipes, wires etc.

### SUMMARY OF THE INVENTION

One object of the present invention is that forces exerted by or on a cable in any direction should be taken up. A further object is that relatively simple and yet reliable devices should be used to take up the forces. By having relatively simple devices to take up the forces costs can be kept relatively low. A further object is that the contact with the cables should be elastic, i.e. the cables should be able to move in a certain degree in relation to the fixing points of the cable retention devices. Still a further object is that in some installations it should be possible to install and uninstall one or more cables without influencing the mounting of all other cables.

The present invention could replace many of the different types of cable clamps or cable clips used today, as well as clamps or clips for pipes and wires.

The inventions is based on modules placed around each cable, and which modules are then placed inside a frame construction. The frame construction is rigid and is made of a firm material not bulging under the expected forces. The frame constructions may be made of metal, composite materials, plastics or other suitable materials. The modules inside the frame constructions are compressed in some way to give a retention force on the cables inside the modules. As the modules are placed inside the frame construction they will press on the cable under compression, as they are not free to expand outwardly.

According to the invention there is some elasticity or flexibility in the connection between a cable and a structure to which the cable retention device is fixed. At the same time there is a firm contact between a cable and a module, due to high friction in said contact. Furthermore, due to the elasticity of the modules the risk of damage to the cables is relatively low. In the cable clamps normally used today parts of metal will be pressed against the cables and the harder the cable clamp is tightened the greater is the risk of damaging the cable.

In use at for example wind power stations the cable retention devices are used for relatively heavy cables, necessitating relatively large traction relief. Thus, each cable retention device must be able to take up a substantial force. In testing cable retention devices of the present invention has proved to be able to take up more than 500 kg.

In the description below expressions such as “bottom”, “side”, “vertical” and possible further similar expressions are used for ease of description and often with reference to directions shown in the attached Figs. In use the devices of the present invention may be placed in any orientation.

### BRIEF DESCRIPTION OF THE DRAWINGS

The invention will be explained further below by way of examples and with reference to the enclosed drawings. In the drawings:

FIG. 1 is a perspective view of a cable retention device according to the present invention attached to a cable ladder or cable rack;

FIG. 2 is a plan view of the cable retention device of FIG. 1;

FIG. 3 is a perspective view of parts of the cable retention device of previous Figs. in a not assembled condition;

FIG. 4 is a perspective view of an alternative embodiment of a cable retention device according to the present invention;

FIG. 5 is a perspective view of a third embodiment of a cable retention device according to the present invention;

FIG. 6 is a perspective view of a fourth embodiment of a cable retention device according to the present invention;

FIG. 7 is a plan view of the cable retention device of FIG. 6;

FIG. 8 is a perspective view of a fifth embodiment of a cable retention device according to the present invention;

FIG. 9 is a plan view of a detail of the cable retention device of FIG. 8;

FIG. 10 is a perspective view of a cable retention device according to the present invention, illustrating a supplement;

FIG. 11 is a perspective view of a sixth embodiment of a cable retention device according to the present invention;

FIG. 12 is a perspective view of a seventh embodiment of a cable retention device according to the present invention;

FIG. 13 is a perspective view of a part of the cable retention device of FIG. 12;

FIG. 14 is a perspective view of an eight embodiment of a cable retention device according to the present invention;

FIG. 15 is a perspective view of a ninth embodiment of a cable retention device according to the present invention;

FIG. 16 is a perspective view of a first example of a module to be received in the cable retention devices of the present invention;

FIG. 17 is a plan view of a second example of a module to be received in the cable retention devices of the present invention;

FIG. 18 is a cross sectional view taken along the line A-A of FIG. 17;

FIG. 19 is a plan view of a third example of a module to be received in the cable retention devices of the present invention;

FIG. 20 is a cross sectional view taken along the line B-B of FIG. 19;

FIG. 21 is a side view of a tenth embodiment of a cable retention device according to the present invention; and

FIG. 22 is a side view an eleventh embodiment of a cable retention device according to the present invention.

### DETAILED DESCRIPTION OF PREFERRED EMBODIMENTS

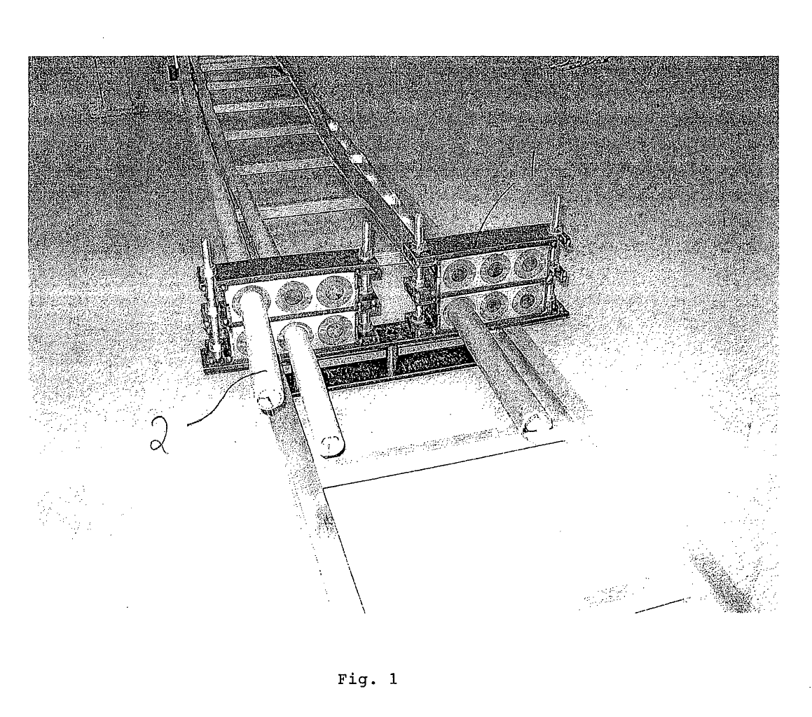

In the embodiment of FIG. 1 two frame constructions 1 are shown, inside which a number of modules are received. The modules are to receive a cable 2 each. In the shown example one of the frames receive one cable 2 and the other frame two cables 2. The number of cables received in each frame 1 may vary and normally most of the modules will have a cable 2. In the various examples below cable retention devices are shown having different numbers of columns and receiving different numbers of modules. A person skilled in the art realises that the numbers of columns and modules may vary as well as the dimensions of the columns and modules. However, the dimensions of co-operating modules and columns are adapted to each other.

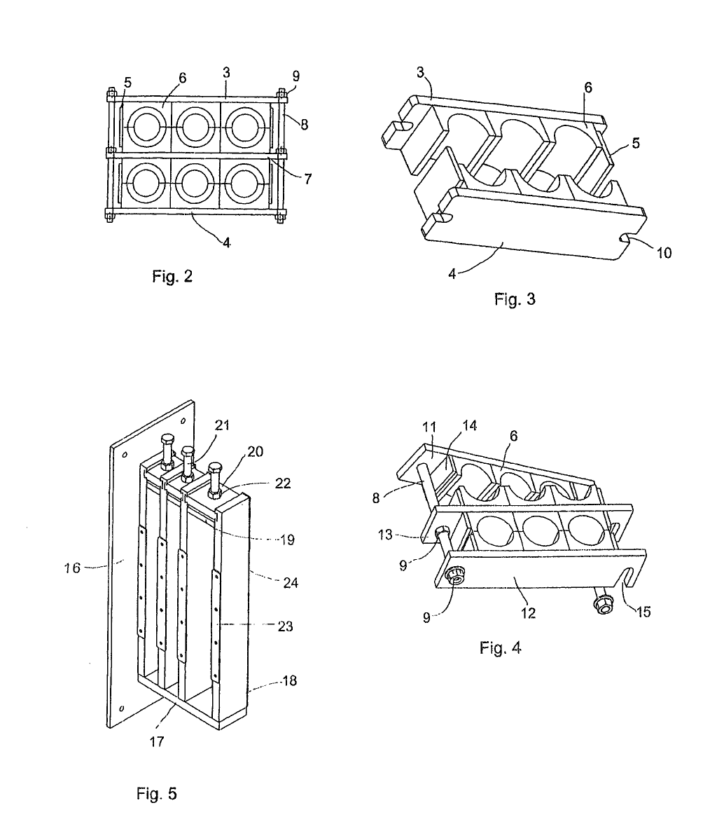

Each frame construction 1 comprises a number of plates 3, 4, 7 placed aligned one over the other. Thus, there will one outer plate 3, 4 at each end and a number of intermediate plates 7. In the shown example of FIGS. 1 and 2 there is only one intermediate plate 7, but a person skilled in the art realises that the number of intermediate plates may be any number from zero and upwards. In the example of FIG. 3 there is no intermediate plate. Between the plates 3, 4, 7 a number of modules are received, which modules are formed of two module halves 6. In this example the module halves 6 are fixed to the plates 3, 4, 7, preferably with an adhesive. The fixation may also be accomplished by means of Velcro, nailing, riveting or a composite moulding technique. The outer plates 3, 4 have module halves 6 on only one side, while the intermediate plates 7 have module halves 6 on two sides. Thus, in assembled condition one or more rows of modules are formed between the plates 3, 4, 7. At the ends of each row of modules a support plate 5 is arranged to hold to the modules together and to support compression of the modules. In this example the support plates 5 are fixed to a module half 6 at each end of the row of modules. In other embodiments the support plates 5 are fixed to or are parts of the plates 3, 4, 7. The plates 3, 4, 7 are fixed to each other by means of rods 8, which rods are threaded, at least partly to co-operate with nuts 9. The rods 8 are received in grooves 10 at the ends of the plates 3, 4, 7. The grooves 10 at the ends of the plates 3, 4, 7 are open outwardly in such a way that the rods 8 may be inserted in the grooves 10. In other embodiments circular openings replace one or both grooves 10 of each plate.

The module halves 6 are normally made of a compressible material and/or have compressible parts. As the cable retention device is assembled the modules are to be compressed, whereby each module will be pressed against a possible cable 2 received in the middle of the module. Thereby there will be a firm contact, due to high friction, between cable and module. At the same time an elastic connection will be formed between each cable 2 and the structure to which the cable retention device is fixed.

In use a number of cables 2 are placed in the cable retention device, whereby each cable is received in one module each. When all the cables 2 have been placed in one module half 6 each, the module halves are brought together forming rows of modules. Then rods 8 are placed in the grooves 10 of all plates 3, 4, 7 of the cable retention device. For every plate 3, 4, 7 one nut 9 is arranged one each rod 8. The nuts 9 at the ends of each rod 8 are placed outside the plates 3, 4, while the nuts 9 at the other plates 7 may be placed on any side of the plate 7. By tightening the nuts 9 the modules will be compressed.

In FIG. 1 the cable retention device is shown attached to a cable ladder, by means of clamping to the side rails of the cable ladder. This is only one example of attachment of a cable retention device according to the present invention to a structure.

The cable retention device of FIG. 4 has two outer plates 11, 12, i.e. plates placed at opposite ends of the cable retention device. It also has an intermediate plate 13. All three plates 11, 12, 13 are placed one above the other at a distance when the cable retention device is assembled. Module halves 6 are attached to the plates 11, 12, 13. The outer plates 11, 12 have module halves 6 on only one side, while the intermediate plate 13 has module halves 6 on both sides. In the same way as described above the plates 11, 12, 13 of the cable retention device are held together by means of threaded rods 8 and nuts 9 received on the rods 8. In this example each plate 11, 12, 13 has a one circular hole at one end and a groove 15 at the other end. The rods are received in the openings and grooves 15 of the plates 11, 12, 13. The groove 15 of each plate is open at one long side, whereby each plate can be turned in and out of contact by one rod 8. Thus, each plate 11, 12, 13 is pivotally connected to the rest of the cable retention device. Hereby the mounting and dismounting of the cables are made easier by twisting the plates 11, 12, 13 relative each other at the same time as the parts of the cable retention device are held together by the rod 8 received in the circular openings of the plates 11, 12, 13. The module halves 6 on the plates 11, 12, 13 are arranged in row and between support plates 14 extending at right angles from the plates 11, 12, 13. The module halves 6 may either be glued to the plates 11, 12, 13 or held at the plates by being pressed in between the support plates 14 or a combination of the two. Alternatively the module halves 6 are composite moulded to the plates 11, 12, 13 and the support plates 14. In the assembled condition gaps are formed between the support plates 14 of opposing plates 11, 12, 13. These gaps represent the maximal possible compression of the modules and that a correct compression is achieved when the gaps are closed.

In the example of FIG. 5 a cable retention device is shown arranged with an attachment plate 16, which attachment plate is intended for fixation to a part of a structure. The cable retention device has one bottom plate 17, a number of side plates 18 extending at right angle from the bottom plate 17 and at a distance from each other. Thus, columns are formed between the side plates 18. At the end of each formed column opposite the bottom plate 17 a compression plate 19 connected to an upper plate 20 are arranged. The compression plate 19 is received in such a way that it my slide inside the formed column, while the upper plate 20 is fixed to the side plates 18. In the shown example the upper plates 20 are received in dovetails of the side plates 18. A screw 21 and nut 22 is arranged for each pair of upper plate 20 and compression plate 19. Each screw 21 goes through a circular opening in one upper plate 20 and the free end of the screw is to abut a compression plate 19. The modules inside the cable retention device are compressed in that each compression plate 19 is pressed against the modules of respective column. The nut 22 is arranged on the outside of the upper plate 20 to lock the screw 19 in a desired position.

In use modules are to be received in the columns of the cable retention device and to keep the modules in place inside the columns stops 23, 24 are arranged on the side plates 18. The stops 18, 19 project slightly over the edge of the side plates 18 and each has a length that is such that modules placed inside the columns of the cable retention device cannot be lifted out of the cable retention device, but have to be inserted and taken out by sliding via one column end after release of the upper plate 20 and compression plate 19. The stops 23, 24 have a length adapted to the dimensions of the modules. The stops 23, 24 may be fixed to the side plates 18 in any suitable way such as by means of screws, rivets, soldering, welding, gluing or composite moulding. The stops 23, 24 may also be integrated parts of the side plates 18.

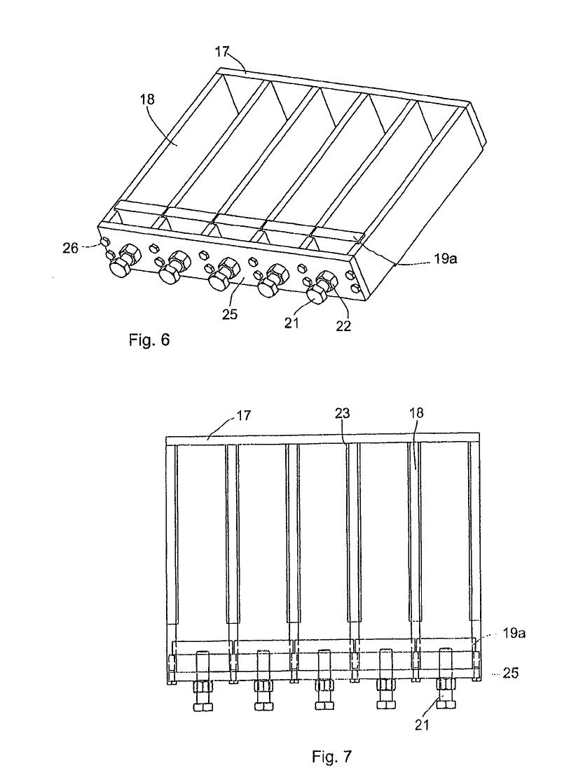

The cable retention device of FIGS. 6 and 7 resembles the cable retention device shown in FIG. 5. The main differences being that a single upper plate 25 replaces the several upper plates 20 of FIG. 5. Thus, also this cable retention device has a bottom plate 17, a number of side plates 18 and compression plates 19a. In this example the compression plate 19a has protruding edges resting on the sides of the side plates 18 forming the compartment in which the compression plate 19a slides. Screws 21 and nuts 22 are arranged to control the positions of the compression plates 19a. Furthermore, stops 23, 24 are arranged in the same way as described above to keep the modules in place inside the columns of the cable retention device. Said stops 23, 24 are only shown in FIG. 7. The single upper plate 25 is fixed to the side plates 18 by means of a number of screws 26.

The main difference in handling the cable retention devices of FIGS. 6 and 7 compared to the cable retention device of FIG. 5 is that to mount or dismount a cable the compression of all columns has to be released. In the example of FIG. 5 only the compression of that column in which the cable is to be mounted and dismounted has to be released. Thereby, it is possible to keep some cables in position when other cables are removed or inserted.

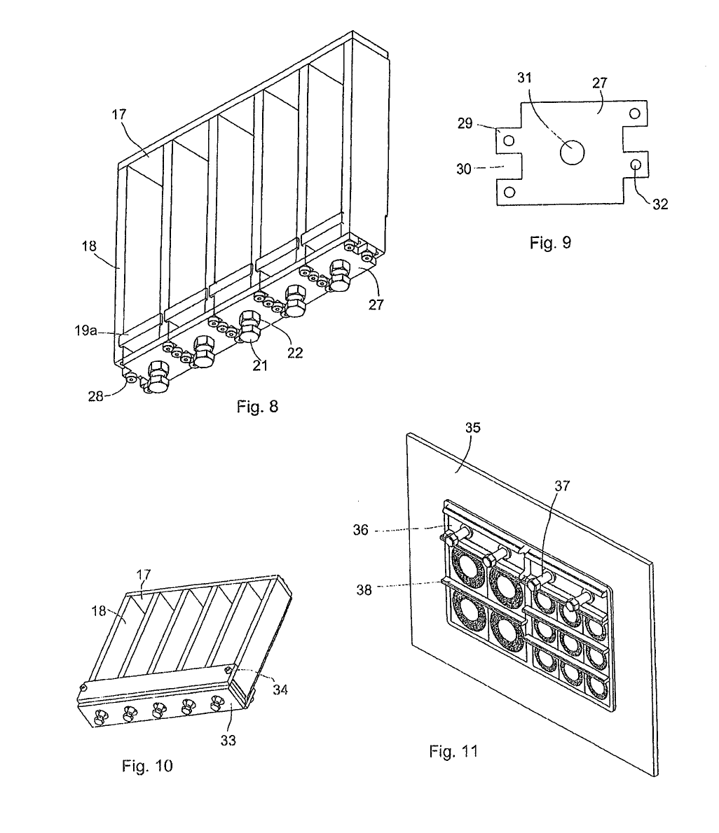

In FIGS. 8 and 9 a further example of a cable retention device is shown, which resembles the cable retention devices shown in FIGS. 5-7. The only difference in relation to the example of FIG. 5 is the form of the upper plates 27 and the way said upper plates 27 are fixed to the side plates 18. Each upper plate 27 has two protruding parts 29 on two of its opposing sides, which protruding parts 29 all are arranged at different position and whereby a cut-out 30 is formed on each side between two protruding parts 29. The protruding parts 29 of one upper plate 27 will fit into cut-outs 30 of an adjacent upper plate 27. In the centre of each upper plate 27 a circular opening 31 is formed to receive a screw 21 to control the position of a compression plate 19a in co-operation with a nut 22 in the same way as described above. In each protruding part 29 of each upper plate 27 a circular opening 32 is formed to receive a screw 28. By means of the screws 28 the upper plates 27 are fixed to the side plates 18 of the cable retention device. Although not explicitly shown stops 23, 24 are normally also arranged in the embodiment of FIG. 8, to keep the modules in place inside respective column.

In FIG. 10 a U-shaped cover 33 is illustrated. The cover 33 is fixed to the cable retention device by means of screws 34 at the outer side plates 18. The cover 33 has openings to receive the compression screws 21. The cover 33 covers the compression plates 19 and the upper plates 20, 25, 27. The cover 33 may be combined with any of the cable retention devices described above and will give some protection against dust, dirt etc. deteriorating the repeated function of the screw 21 and nuts 22. Furthermore, the cover 33 aids in keeping the upper plates 20, received by dovetail joints with the side plates 18 of FIG. 5, in the correct position in e.g. vibrating environments.

In the embodiment of FIG. 11 a cable retention device is arranged with an attachment plate 35, which attachment plate 35 is to be attached to a suitable structure. Alternatively, the cable retention device may be welded, bolted or cast directly to the structure. The shown cable retention device has two compartments each receiving a number of modules, a number of partitions and a compression unit in the form of a compression wedge 36. The compression wedge 36 has parts that slid relative each other along inclined contact surfaces, by means of screws 37. By the sliding the outer dimension of the compression wedge 36 is altered and the modules will be compressed. In the shown example the screws 37 have two counter-directed threads, which means that the compression of the compression wedge can be regulated from one side.

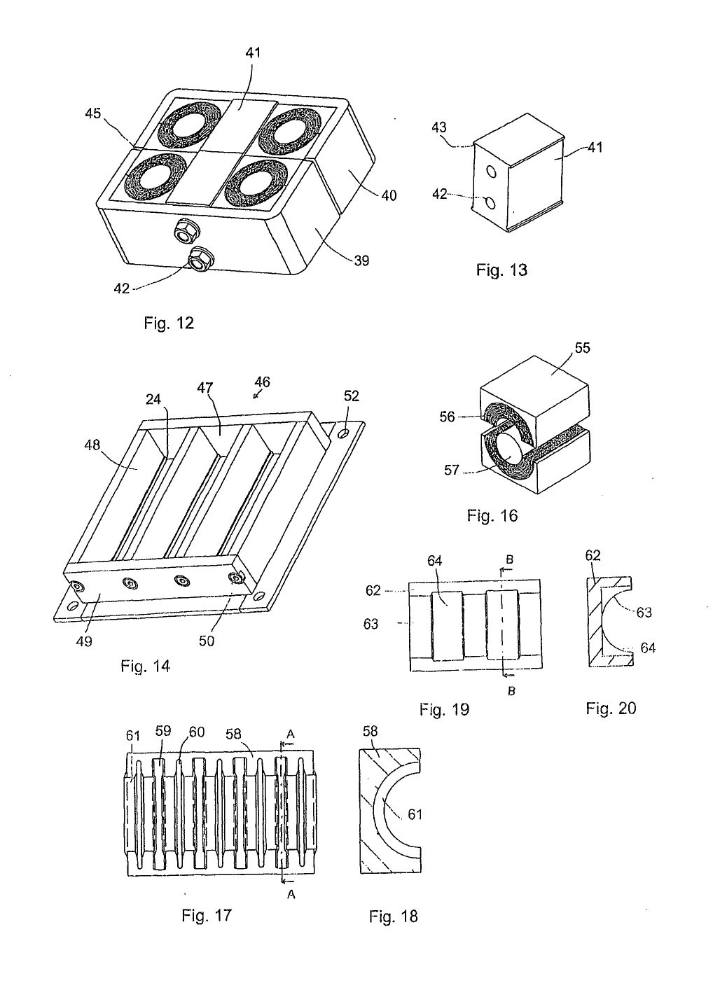

In FIGS. 12 and 13 a further alternative cable retention device is shown. It is formed of two generally U-shaped frame parts 39, 40. Inside each frame part 39, 40 modules are received. In the middle of the cable retention device two blocks 41 of a compressible material are arranged. Each block has two through openings 44 for receiving screws that goes between long sides of the two frame parts 39, 40. The blocks 41 are shown with protruding edges 43, between which the modules are to be received. The frame parts 39, 40 are assembled in such a way that they form an inner rectangular space, in which the modules and the blocks 41 are received. Furthermore, due to the dimensions of the compressible blocks 41a small gap 45 is formed on two opposing sides between the frame parts 39, 40 before compression. The gaps 45 give the maximal possible compression and the correct compression when the gaps are closed. In use the compressible blocks 41 will be compressed in that nuts 42 received on the screws are tightened, whereby the compressible blocks 41 will expand in directions in right angle to the screws and compress the modules.

In FIG. 14 a further example of a cable retention device 46 according to the present invention is shown. The cable retention device 46 has a bottom plate 47 and a number of side plates 48, extending at right angles from the bottom plate 47. Normally the side plates 48 are attached to the bottom plate 47 by welding, even though soldering, gluing, attachment means or moulding may be used. An upper plate 49 is fixed to the side plates 48 by means of screws 50 at the ends of the side plates 48 opposite the bottom plate 47. The screws 50 are shown as socket head cap screws in this example. A person skilled in the art realises that any suitable type of screw may be use in this example as well as the other examples described here. A number of compartments are formed between the bottom plate 47, the side plates 48 and the upper plate 49. Modules are to be received inside the compartments formed. The cable retention device 46 of this example has a peripheral flange 51 for attachment to a structure. The compression of the modules of this cable retention device 46 is given in that the outer dimensions of the modules received in one compartment are slightly larger than the available space inside the compartment. Thereby, the modules will be compressed as the upper plate 49 is fixed to the side plates 48 by means of the screws 50.

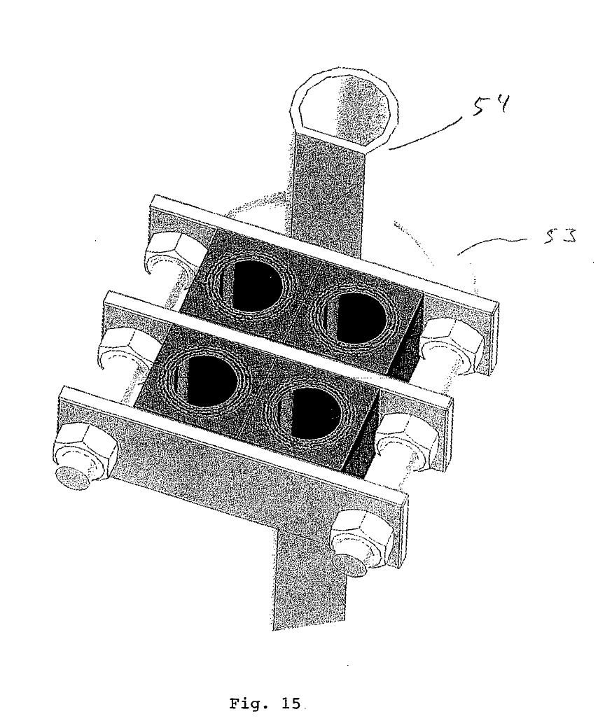

In FIG. 15 a further example for a cable retention device according to the present invention is shown. The cable retention device of this example mainly corresponds with the cable retention devices of FIGS. 2-4. The only main difference being that a single U-shaped rod 53 replaces the two rods at each side of the cable retention device. The U-shaped rod 53 forms an arc at one side of the cable retention device that may be used as a clamping device. In the example of FIG. 15 the cable retention device is clamped to a structure part 54, which is a rod going from the top to the bottom of a tower of a wind power station. A number of cable retention devices may be placed at regular intervals of said structure part 54.

In the example of FIG. 21 the cable retention device of the present invention has the form of a number of frames 65 placed side-by side on a plate 68. The frames 65 resemble arches, but with rectangular shape and have flanges directed outwardly and perpendicular from the sides of the frame at the open end of the archlike frame. Each flange has an opening to receive a bolt 69, which bolt also goes through an opening of the plate 68. Normally, the opening of the plate is threaded but in other embodiments the fixation is given by means of bolts and nuts. Depending of the needs of a specific installation the number of frames 65 received on the plate 68 varies. Of course in such cases the length of the plate 68 will be adapted to the number of frames 65 received. Inside the frame modules of different sizes may be received. In the example shown in FIG. 21 modules, formed of two module halves 66, and intended for one large cable each are combined with modules, formed of two module halves 67, and intended for two smaller cables each. The outer dimensions of the combination of modules received in each frame 65 are somewhat bigger than the inner dimension of the frame 65. Thus, the modules will be compressed when the frames 65 are fixed to the plate 68, which will give a retention force on any cables received inside the modules. Thus, as indicated in this example it is possible to arrange a combined retention device for a large number of cables of different diameters. To adapt the embodiment to different situations the number of frames 65 and the size of the modules inside the frames may be varied.

In FIG. 22 a further example of a cable retention device according the present invention is shown. In this example the frame construction has the form of a cable clamp formed of two clamp parts 70, 71. A first clamp part 70 is formed for attachment to a specific structure. A second clamp part 71 is formed for fixation to the first clamp part 70. Each clamp part 70, 71 has a rounded portion in which a module half 72 is received. In this case the module halves 72 are glued to respective clamp part 70, 71. Each module half 72 has the form of a generally semicircular set of peelable layers or sheets. The two module halves 72 will form a full circle when compressed by the clamp parts 70, 71 being fixed to each other. The peelable sheets adhere strong enough to each other to stick together but loose enough to be peeled off by hand. Normally a module support 73 is placed at each end of each module half 72 to give a proper positioning. In use the first clamp part 70 is fixed to some kind of structure. The module halves 72 are adapted to the dimension of the cable to be received by peeling off a suitable number of layers. With the cable placed inside the module halves 70 the second clamp part 71 is fixed to the first clamp part 70, by means of bolts, bolts and nuts or other suitable fixation means. To give retention force on the cable the outer dimension of the cable should be somewhat bigger than the inside dimension of the module formed, which is controlled by the number of sheets peeled off. A person skilled in the art realises that the form of the first clamp part may vary as long as it has a rounded part for cooperation with the second clamp part in forming the cable retention device.

A person skilled in the art realises that the cable retention device of the present invention may be varied in many different ways. Parts shown in one example may, if possible, replace parts of other shown examples. However, in all embodiments a number of compressible modules to receive cables are placed inside of some kind of frame construction and the modules inside the frame construction are compressed, either by means inside the frame construction or by assembling the frame construction.

The modules of the cable retention device may have different designs. As long as they give a firm contact between module and cable, at the same time as there is an elastic or flexible connection between cable and structure, to which the cable retention device is attached.

In FIGS. 16-20 three different designs of modules are shown. The module shown in FIG. 16 is formed of two module halves 55, forming an opening when assembled. In the opening a centre core 57 is received. Normally the centre core 57 adheres slightly to one of the module halves 55 in such a way that the centre core 57 can be loosened by hand. Thus, a gentle adhesive may be used. Furthermore, on the inside of the module halves 55 a number of sheets 56 are arranged. The sheets 56 are arranged to adhere to each other but in such a way that the sheets 56 may be peeled off one at the time by hand. In use the number of sheets 56 peeled off is adapted to the diameter of the cable to be received inside the module. Thus, a module of this kind may be used for cables of varying diameter. If not all modules in a cable retention device are to receive a cable at assembly the centre core 57 is kept in place between the module halves 55. If at some later stage a cable is to be received the centre core 57 is taken away and a number of sheets 56 are peeled off, whereby the number of sheets 56 peeled off depends on the diameter of the cable.

The module halves 55 are made of a rubber material giving an elastic connection between cable and structure. The rubber material may be EPDM or any other rubber material e.g. NR, SBR, NBR, EPM) giving an elastic connection. Due to the elastic contact forces in different directions are taken up. The forces may be axial, radial, torsional or vibrations.

The modules of FIGS. 17 and 18 are also made of two module halves 58, forming a central opening when the two halves 58 are assembled and mounted in a cable retention device. Also in this embodiment a centre core may be received inside the formed module, which core is taken away when a cable is to be received. On the inside of each module half 58 a number of radial grooves 59, 60 are arranged. In the shown embodiment every second groove 59 is formed to receive a land of a possible centre core (not shown), having four lands having a cross section with straight angles. Thus, the grooves 59 receiving the lands of the centre core have also a cross section with straight angles. The centre core is kept in place by co-operation between the lands of the centre core and the grooves 59 of the module halves 58 adapted to the form of the lands. The other grooves 60 may have any cross section but flanges 61 should be formed between the grooves 59, 60. In the shown example the grooves 60 have a rounded form in cross section. In embodiments where no centre core is to be received the grooves 59, 60 may all have the same shape. The flanges 61 are to be pressed against a cable received inside the module, whereby the flanges 61 will give after and be folded. Thus, the foldable flanges 61 means that also in this case there will be an elastic connection between cable and structure, whereby forces can be taken up in said elastic connection. Hereby the elastic connection can be said to be given by the geometric design. If the modules are made of an elastic material, this will also contribute to the elastic connection. A person skilled in the art realises that this geometric design may have many different shapes. These modules are either made of an elastic rubber, such as EPDM, or a plastic.

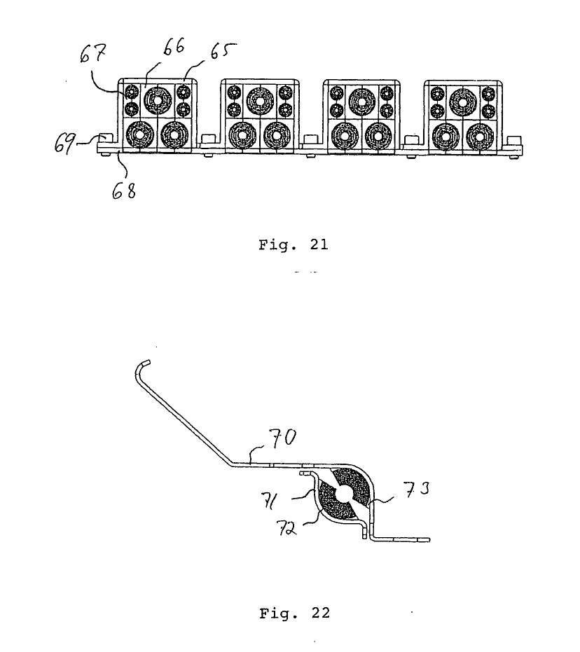

The modules of FIGS. 19 and 20 are formed of two halves 62, which form a central opening when assembled and mounted inside a cable retention device. In the central opening a centre core may be received. The possible centre core is normally lightly adhered to one or both module halves 62 by means of an adhesive. The purpose of the adherence is only to keep the centre core in place and should be weak enough to be broken by hand when a cable is to be received. On the inside of the module halves 62 there are raised parts 63, having a radius adapted to the cable to be received. The raised parts 63 adapted to the cable to be received is placed at least at each end of each module half 62 and in the middle of the module half 62. Between the raised parts 63 adapted to the cable are lowered parts 64, having a cross section with straight angles, i.e. the walls of said lowered parts 64 are parallel with the outer surfaces of the module half 62. When a cable is received inside the module inside a cable retention device, it will be compressed at the raised parts 63 adapted to the diameter of the cable. At the same time the cable will be able to expand somewhat in the lowered parts 64 between the raised parts 63 adapted to the cable. The elastic contact may be enhanced in that the module halves 14 are made of a rubber material, such as EPDM. In some embodiments the modules are made of a plastic. By the design of the modules the cables are held at three areas inside each module with an open space in-between. This type of module is especially suitable to take up tension forces, i.e. forces in the axial direction of the cable.

Irrespectively of which kind of modules that are used the diameter of the central opening, formed when two module halves are brought together, should be slightly smaller than the diameter of the cable to be received, in a non-compressed condition.

As indicated above each module may be furnished with a centre core, but it is not absolutely necessary. The centre cores are beneficial in order to hinder modules not receiving any cables from collapsing when compressed.

The cable retention devices of the present invention are attached to a structure in any suitable way. The type of attachment suitable depends on the structure to which the cable retention device should be attached. The attachment may have the form of screws, bolts, pins, clips, rivets, arcs and/or clamps or may be done by welding, soldering, gluing or casting.

As indicated above the present invention is mainly developed for receiving relatively large cables, for example at wind power stations, which means that they should be able to carry relatively large loads. In some instances each cable retention device should be able to carry loads of at least 150 kg, preferably at least 300 kg and most preferred at least 500 kg. The cable retention devices of the present invention are designed to handle such loads but at the same time the cable retention devices of the present invention may be used with cables of much lower weights.

1. A cable, pipe or wire retaining device to receive cables pipes or wires and take up forces actuated by or on the cables, pipes or wires, wherein the cables are received inside modules, which modules are received inside a rigid frame construction and that means are arranged to compress the modules and that it is furnished with attachment means for attachment to a structure.

2. The device of claim 1, wherein the frame construction is formed of two outer plates and possible intermediate plates, that module halves are attached to one side of each outer plate and to both sides on the possible intermediate plates, and that the plates are brought together by means of rods received at opposing ends of each plate on which rods nuts are received by means of threads, whereby the module halves forms modules to receive possible cables, pipes or wires.

3. The device of claim 2, wherein support plates are arranged at right angles from the outer and possible intermediate plates, between which support plates the module halves are placed abutting each other.

4. The device of claim 2, wherein the module halves are fixed to the outer and possible intermediate plates by means of an adhesive, Velcro, nailing, riveting or a composite moulding technique and/or that the outer and possible intermediate plates are arranged pivotally in relation to each other.

5. The device of claim 1, wherein the frame construction is formed of a bottom plate, two or more side plates, one or more upper plates and one or more compression plates, which compression plates are received in a sliding way between two side plates, that the side plates are arranged at right angles to the bottom plate and the one or more upper plates to form a frame construction having one or more compartments, whereby each compartment is formed between the bottom plate, two side plates and one upper plate, that a row of modules is placed between adjacent side plates and that the position of the compression plates, is controlled by means of screws received in openings of the one or more upper plates and where the ends of the screws are to abut the one or more compression plates.

6. The device of claim 5, wherein the one or more upper plates are fixed to the side plates by means of screws or by a dovetail joint.

7. The device of claim 5, wherein only one upper plate is arranged.

8. The device of claim 5, wherein several upper plates are arranged having protruding parts and cut-outs placed in such a way that the protruding parts goes into cut-outs of adjacent upper plates at assembly.

9. The device of claim 5, wherein stops are arranged to protrude over the edges of the side plates and/or that a U-shaped cover is arranged over the one or more upper plates and compression plates.

10. The device of claim 1, wherein a compression unit is placed inside the frame construction.

11. The device of claim 10, wherein the compression unit is a compression wedge.

12. The device of claim 10, wherein the compression unit is one or more compressible blocks placed between modules in a frame construction of two frame parts forming a gap, that screws are arranged going through the compressible blocks and the frame parts, wherein nuts are arranged on the screws to reduce the gap between the frame parts and thereby compressing the compressible blocks.

13. The device of claim 1, wherein the frame construction is formed of one bottom plate, two or more side plates and one upper plate, that the side plates are arranged at right angles to the bottom plate and the upper plate to form a frame construction having one or more compartment, whereby each compartment is formed between the bottom plates and the upper plate, is fixed to the side plates and that the inner dimensions of slightly smaller than the total outer of modules received in the compartment, will be compressed as the upper plate is fixed side plates.

14. The device of claim 1, wherein the frame construction is formed of one or more frames fixed side-by-side at a plate and that each frame has a rectangular shape with one open side, which open side is facing the plate.

15. The device of claim 1, wherein the frame construction has the form of two clamp parts, of which a first clamp part is to be fixed to a structure and a second clamp part is to be fixed to the first clamp part, that each clamp part has a rounded part on the inside of which a module half, in the form of a semicircular set of peelable layers, is fixed.

16. The device of claim 15, wherein the module halves are fixed to the clamp parts by plate, two side that the upper plate by means of screws each compartment is dimensions of a row whereby the modules to the means of glue and that a module support is placed at each end of each module half.

17. The device of claim 1, wherein the attachment means is a plate or a flange fixed or integrated with the frame construction or a clamp device and/or that the attachment is accomplished by welding, bolting or casting directly to the structure.

18. The device of claim 1, wherein the attachment means has the form of a clamp, which clamp is formed by a U-shaped rod holding plates of the frame construction together and at the same time forming an opening between the U-shaped rod and one outer plate of the frame construction, in which opening a structure part is clamped.

19. The device of claim 1, wherein the modules are compressible and made of a rubber material, such as EPDM.

20. The device of claim 19, wherein sheets that may be peeled off are placed on the inner diameter of the modules to adapt the inner diameter of each module to the respective cable, pipe or wire received.

21. The device of claim 1, wherein the modules have flexible flanges going into contact with the cables, pipes or wires received in the modules.

22. The device of claim 1, wherein the modules have at least three raised parts for direct contact with a received cable, pipe or wire and having lowered parts, without contact with the cable, pipe or wire between the raised.

23. The device of claim 1, wherein it is used in a wind power station.

24. Use of the device of claim 1, wherein it is used to take up loads of at least 150 kg, preferably at least 300 kg and most preferred at least 500 kg.
